(19) United States
(12) Patent Application Publication
(10) Pub. No.: US 2022/0175602 A1
(43) Pub. Date: Jun. 9, 2022

(54) BEDSORE-PREVENTING MATTRESS COMBINED WITH SOUND VIBRATION MODULE AND AIR FIBERS, AND OPERATING METHOD THEREFOR

(71) Applicant: HALCYON INC., Seoul (KR)

(72) Inventor: Ji Sun LEE, Seongnam-si (KR)

(73) Assignee: HALCYON INC., Seoul (KR)

(21) Appl. No.: 17/606,435

(22) PCT Filed: Nov. 25, 2020
(86) PCT No.: PCT/KR2020/016808

§ 371 Date: Oct. 25, 2021

(30) Foreign Application Priority Data
Dec. 2, 2019 (KR) 10-2019-0158501
Oct. 26, 2020 (KR) 10-2020-0139668

(51) Int. Cl. A61G 7/057; A61H 23/02

(52) U.S. Cl. CPC A61G 7/05769; G06F 3/165; A61H 23/0236

(57) ABSTRACT

A mattress combined with a sound vibration module and air fibers, and an operating method therefor. An air mattress to which air fibers are applied comprises a sound vibration module comprising a speaker, a tactile transducer, a controller, and an amplifier, the sound vibration module being manipulated to generate low-frequency vibration through the conversion of an input sound source into vibration or sound after being amplified, and at the same time emit same as sound. While sound vibration stimuli are applied to the skin through the sound vibration module, contact pressure is distributed on the air mattress to which air fibers are applied, and a static pressure state can be maintained as a fluctuating pressure state. Moreover, the effect of improving muscle strength by healing of muscle cells, blood flow improvement, and low-frequency vibration can be realized through vibration stimulation, to thereby stably prevent the occurrence of bedsore.

### TECHNICAL FIELD

The present invention relates to a bedsore-preventing mattress combined with a sound vibration module and air fibers, and an operating method therefor.

### BACKGROUND ART

In general, bedsore means a disease that causes a damage (an ulcer) of the skin and subcutaneous tissues due to blood-flow disorders because pressure is continuously applied to a body part when a patient lies in the same position for a long time.

Bedsore is typically seen in patients who have mobility difficulties, patients who are in an unconscious state, patients who cannot move due to injury of cranial nerves or injury of spinal nerves, critical patients, and patients who have general prostration.

Such patients are difficult to feel pressure even though pressure is continuously applied to the same position or are difficult to change their positions by themselves even though feeling such pressure. So, the patients suffer from bedsore.

Therefore, recently, in order to prevent bedsore, air mattresses which can change pressure transferred to a patient's body by controlling air supplied into the mattress have been used.

Such a conventional air mattress has a structure that both ends of each of I-beams are adhered onto the inner surfaces of upper and lower sides of the air mattress so as to divide the inside of the air mattress into several sections and air is injected into the sections of the air mattress. The air mattress keeps its cushiony function and form by pneumatic pressure injected into the sections. A user can set the cushiony level according to the user's body condition by adjusting pneumatic pressure.

However, because the conventional air mattress having the I-beams mounted therein is divided into several sections in the width direction or in the longitudinal direction of the mattress, if pressure is applied to any part, air moves in the same section. Therefore, because the part of the mattress where pressure is applied is pressed and dented, but parts of the mattress where pressure is not applied are relatively expanded and protrude, the mattress generally becomes uneven.

Moreover, if the air mattress repeats expansion and contraction due to repeated use, stress is concentrated on both ends of each of the I-beams joined to the inner surface of the air mattress. So, when the joined parts of the I-beams come off, because the cushiony function and the form-maintaining function are deteriorated, the air mattress cannot be used.

As described above, in consideration of the problems generated from the mattress using coil springs and the mattress using I-beams, an air mattress using yarn fibers has been developed and used.

Such a mattress using fiber yarns has a structure that upper and lower sides of the inside, which have airtightness (air-impermeableness) and liquid-tightness (liquid-impermeableness), are closely connected by fiber yarns, for instance, three or more strands of fiber yarns per 1 cm² and air is injected into the air mattress. Such an air mattress expands as long as the fiber yarns to maintain the form of the mattress.

In the air mattress using fiber yarns, when the upper and lower sides of the inside are closely connected by the fiber yarns, even though pressure is applied to any part, only the part to which pressure is applied is pressed and gets dented but the other parts are not expanded and do not protrude due to the length of the fiber yarns and keep its form as it is, and just pneumatic pressure of the inside increases slightly. Therefore, the air mattress using fiber yarns can prevent that the mattress from generally getting uneven.

Furthermore, because pneumatic pressure in the mattress acts generally uniformly, stress applied to each of the fiber yarns is decreased. Additionally, stress is dispersed since the fiber yarns are connected closely. Thereby, the air mattress using fiber yarns has improved durability since the connected parts of the fiber yarns do not come off.

The conventional air mattress using fiber yarns can disperse body pressure, but cannot prevent bedsore when a patient uses the air mattress since the conventional air mattress is limited to dispersion of contact pressure and intermittent changes of contact points.

### DISCLOSURE

### Technical Problem

Accordingly, the present invention has been made in an effort to solve the above-mentioned problems occurring in the prior arts, and it is an object of the present invention to provide a bedsore-preventing mattress combined with a sound vibration module and air fibers, and an operating method therefor, which can provide a function of contact pressure dispersion by applying air fibers, and can apply sound vibration stimuli to a patient's skin through a sound vibration module having a speaker, a tactile transducer, a controller, and an amplifier which are mounted on the air mattress in order to provide various effects helpful for the human body, such as healing of muscle cells, blood flow improvement, and improvement of muscle strength by low-frequency vibration.

### Technical Solution

To achieve the above objects, the present invention provides a bedsore-preventing mattress combined with a sound vibration module and air fibers including:

an air mattress (100) including an upper fabric (110), a lower fabric (120) arranged below the upper fabric (110) to be spaced apart from the upper fabric at a predetermined interval so as to form an air cushion layer in the mattress, a plurality of air fibers (140) of a fine thread shank type which are vertically connected between the upper fabric (110) and the lower fabric (120) to respond to external pressure, a lateral fabric (130) which seals the periphery between the upper fabric (110) and the lower fabric (120), an air injection part disposed at one side to inject air and seal the air mattress, sound mounting recesses (170) which are formed at both width-directional sides of one side of the longitudinal direction to be spaced apart from each other and to be recessed from the upper surface, and a sonic vibration mounting recess (190) formed in the middle of the longitudinal direction to be recessed from the upper surface; and

a sound vibration module mounted on the air mattress (100) and including a speaker (210), a tactile transducer (220), a controller (230), and an amplifier (240), the sound vibration module being operated to generate low-frequency vibration and to emit sound through vibration change after amplification or sound change after amplification of a sound source.

In another aspect of the present invention, the present invention provides an operating method for a bedsore-preventing mattress combined with a sound vibration module and air fibers including the steps of: (S1) selecting a sound source through the controller;

(S2) retrieving melody information of the selected sound source;

(S3) converting the melody information into a digital sound signal and a low-frequency vibration signal by the amplifier; and

(S4) outputting the converted digital sound signal through the speaker and outputting the converted low-frequency vibration signal through the tactile transducer.

### ADVANTAGEOUS EFFECTS

The bedsore-preventing mattress combined with a sound vibration module and air fibers, and an operating method therefor, according to embodiments of the present invention provides the following effects.

First, the bedsore-preventing mattress combined with a sound vibration module and air fibers, and an operating method therefor can provide a function of contact pressure dispersion by applying air fibers, and can apply sound vibration stimuli to a patient's skin through a sound vibration module having a speaker, a tactile transducer, a controller, and an amplifier which are mounted on the air mattress in order to provide various effects helpful for the human body, such as healing of muscle cells, blood flow improvement, and improvement of muscle strength by low-frequency vibration.

Second, the bedsore-preventing mattress combined with a sound vibration module and air fibers, and an operating method therefor can disperse contact pressure on the air mattress to which air fibers are applied and maintain a static pressure state into a fluctuation pressure state while applying sound vibration stimuli to the skin of a human body through the sound vibration module, thereby preventing generation of bedsore stably.

Third, the present invention can provide various effects helpful for the human body, such as healing of muscle cells, blood flow improvement, and improvement of muscle strength by low-frequency vibration by selectively generating low-frequency sound vibration with a specific range frequency ranging from 20 Hz to 40 Hz through the tactile transducer in response to a patient's disease symptoms according to manipulation of the controller. In addition, the present invention can provide a sound therapy effect by emitting a specific sound source through the speaker by manipulation of the controller.

### DESCRIPTION OF DRAWINGS

FIGS. 1 and 2 are views illustrating a bedsore-preventing mattress combined with a sound vibration module and air fibers, in partial section, according to an embodiment of the present invention.

FIG. 3 is a function block diagram illustrating components of a sound vibration module.

FIG. 4 is a view illustrating an operation algorithm when the mattress in which air fibers and sound vibration act complexly is used.

FIG. 5 is a flow chart illustrating an operating method for the bedsore-preventing mattress combined with a sound vibration module and air fibers according to an embodiment of the present invention.

FIG. 6 is a flow chart illustrating an operating method for the bedsore-preventing mattress combined with a sound vibration module and air fibers according to another embodiment of the present invention.

FIGS. 7A and 7B show comparative illustration between a load processing structure of a conventional bedsore-preventing air mattress to which an air grid and alternate floating or a tilting method are applied and a load processing structure of the bedsore-preventing mattress combined with the sound vibration module and air fibers according to the embodiment of the present invention, wherein FIG. 7A illustrates the load processing structure of the conventional bedsore-preventing air mattress and FIG. 7B illustrates the load processing structure of the bedsore-preventing mattress combined with the sound vibration module and air fibers according to the embodiment of the present invention.

FIG. 8 illustrates a load distribution pressure test of a load distribution of the conventional bedsore-preventing air mattress to which an air grid and alternate floating are applied in comparison with the load distribution of the bedsore-preventing mattress combined with the sound vibration module and air fibers according to the embodiment of the present invention.

### EXPLANATION OF REFERENCE NUMERALS

100: air mattress

110: upper fabric

120: lower fabric

130: lateral fabric

140: air fibers

170: sound mounting recess

190: sonic vibration mounting recess

210: speaker

220: tactile transducer

230: controller

231: sound source connection socket

240: amplifier

### MODE FOR INVENTION

Hereinafter, preferred embodiments of a bedsore-preventing mattress combined with a sound vibration module and air fibers according to the present invention will now be described in detail with reference to the attached drawings.

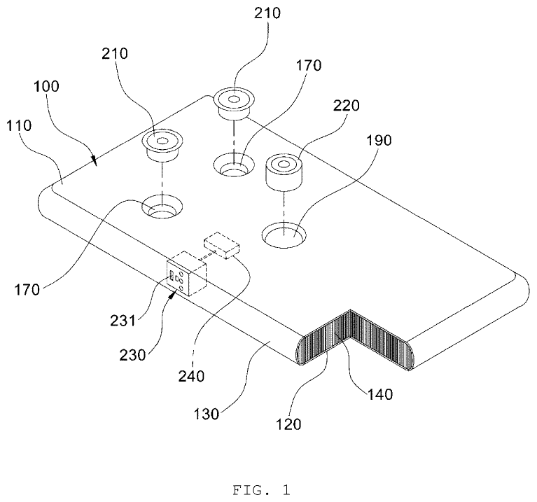

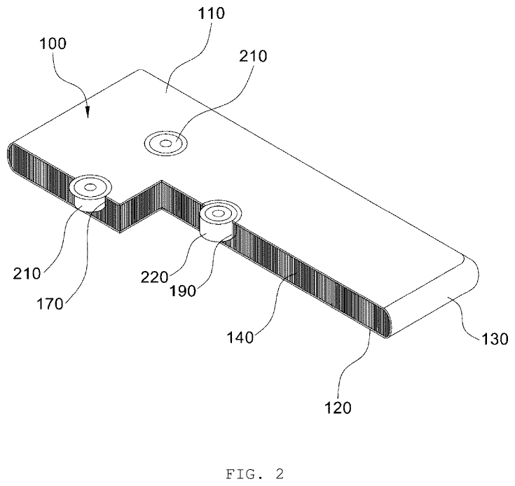

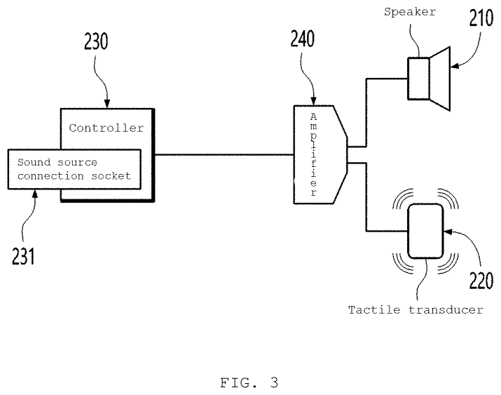

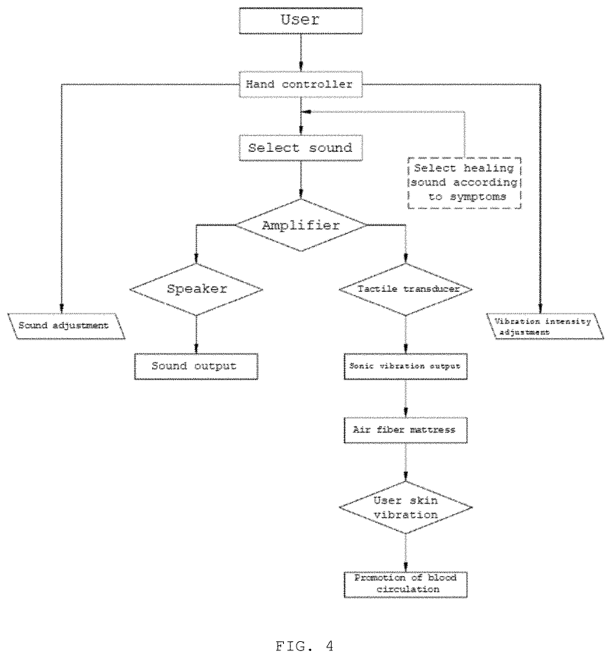

Referring to FIGS. 1 to 4, the bedsore-preventing mattress combined with a sound vibration module and air fibers according to the preferred embodiment of the present invention includes an air mattress 100 to which air fibers are applied, and a sound vibration module.

In this instance, the air mattress 100 to which air fibers are applied includes: an upper fabric 110; a lower fabric 120 arranged below the upper fabric 110 to be spaced apart from the upper fabric at a predetermined interval so as to form an air cushion layer in the mattress; a plurality of air fibers 140 of a fine thread shank type which are vertically connected between the upper fabric 110 and the lower fabric 120 to respond to external pressure; and a lateral fabric 130 which seals the periphery between the upper fabric 110 and the lower fabric 120.

Moreover, the air mattress 110 further includes: an air injection part (not shown) disposed at one side to inject air and seal the air mattress; sound mounting recesses 170 which are formed at both width-directional sides of one side of the longitudinal direction to be spaced apart from each other and to be recessed from the upper surface; and a sonic vibration mounting recess 190 formed in the middle of the longitudinal direction to be recessed from the upper surface.

In the air mattress 100 having the above configuration, preferably, the air fibers 140 are made with fine fiber yarns like superfine fibers, and may be made with carbon fiber yarns.

Furthermore, the upper fabric 110, the lower fabric 120, and the lateral fabric 130 of the air mattress 100 respectively have coating layers formed on the surfaces exposed to the outside. In this instance, the coating layers may be any one among synthetic coating layers of polyvinyl chloride (PVC), polyethylene (PE), and polyurethane (PU).

Additionally, in the air mattress 100, upper and lower ends of the air fibers 140 may be adhered and fixed to the lower surface of the upper fabric 110 and the upper surface of the lower fabric 120.

Of course, the upper and lower ends of each air fiber 140 may be respectively fixed to an upper fixed fabric (not shown) attached to the lower surface of the upper fabric 110 and to a lower fixed fabric (not shown) attached to the upper surface of the lower fabric 120 through crank-type sewing.

In addition, preferably, the upper fabric 110, the lower fabric 120, the lateral fabric 130, and the air fibers 140 of the air mattress 100 are made with fabric or fiber yarns which are certified in antibacterial, anti-inflammation, and non-phthalate.

Meanwhile, the sound vibration module is mounted on the air mattress 100 and includes a speaker 210, a tactile transducer 220, a controller 230, and an amplifier 240. The sound vibration module generates low-frequency vibration and emits sound through vibration change after amplification or sound change after amplification of the sound source inputted by manipulation of the controller 230.

In detail, the sound vibration module includes the speaker 210, the tactile transducer 220, the controller 230, and the amplifier 240, is mounted on the air mattress 100. In this instance, the speaker 210 of the sound vibration module is seated and mounted on the sound mounting recess 170 of the air mattress 100.

That is, in response to the number of the sound mounting recesses 170 of the air mattress 100, a pair of the speakers 210 are mounted in such a way that the speakers 210 are arranged at positions where a patient's ears are located.

Moreover, the tactile transducer 220 of the sound vibration module is seated and mounted on the sonic vibration mounting recess 190 of the air mattress 100.

Furthermore, it is preferable that the controller 230 and the amplifier 240 of the sound vibration module be buried inwards from a lateral side of the air mattress 100.

In connection with inputted sound source, the sound vibration module selectively generates low-frequency vibration which is adjusted into a predetermined range frequency in a low-frequency zone through the amplifier 240 and the tactile transducer 220 in order according to manipulation of the controller.

In this instance, preferably, the low-frequency vibration is adjusted into frequency ranging from 20 Hz to 40 Hz.

Additionally, the sound vibration module can selectively adjust loudness and vibration intensity by manipulation of the controller 230.

In addition, referring to FIGS. 1, 2 and 4, preferably, the sound vibration module is operated by an algorithm that the sound source stored in the controller 230 is outputted into sound through the amplifier 240 and the speaker 210 in order and that the sound source stored in the controller 230 is outputted into sonic vibration through the amplifier 240 and the tactile transducer 220 in order. The outputted sound and sonic vibration are transferred to the user's ears and skin.

Moreover, it is important that the sound vibration module can use sound sources besides the sound source stored in the controller 230.

So, preferably, the sound vibration module further includes a sound source connection socket 231 disclosed at one side of the controller 230 for selectively connecting a portable storage device exposed to the outside.

Meanwhile, the controller 230 is formed in a remote controller type, and preferably, is a wireless controller, but may be a wired controller. Furthermore, the controller 230 may be substituted with a smart phone having an exclusive application.

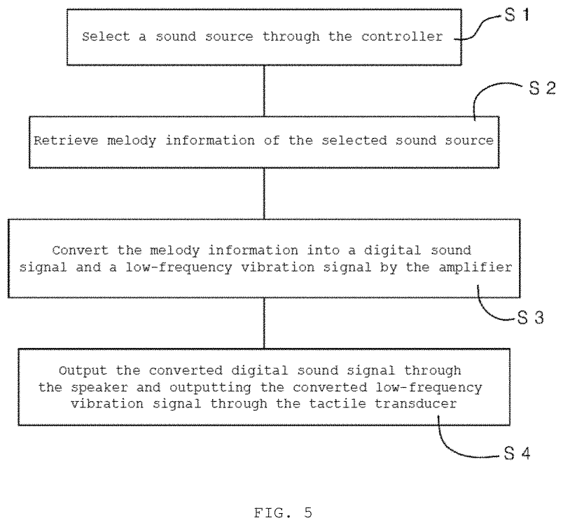

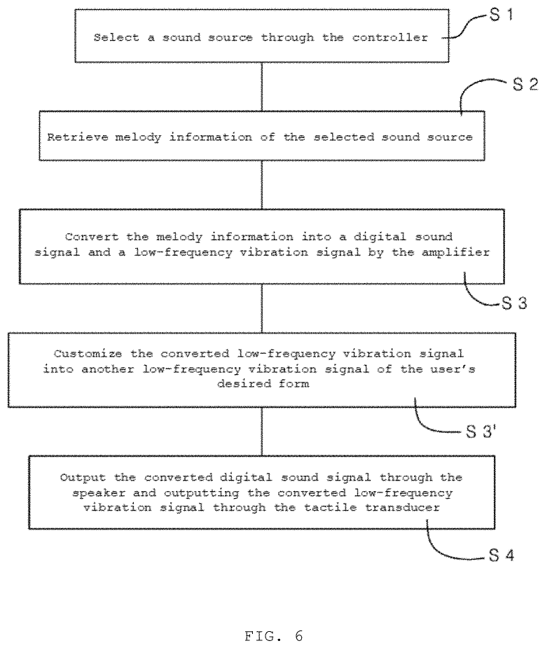

Hereinafter, referring to FIGS. 5 and 6, an operating method for the bedsore-preventing mattress having the above configuration will be described.

As illustrated in FIG. 5, the operating method for the bedsore-preventing mattress includes the steps of: (S1) selecting a sound source through the controller 230; (S2) retrieving melody information of the selected sound source; (S3) converting the melody information into a digital sound signal and a low-frequency vibration signal by the amplifier 240; and (S4) outputting the converted digital sound signal through the speaker 210 and outputting the converted low-frequency vibration signal through the tactile transducer 220.

In the step (S1) of selecting a sound source through the controller 230, a sound source to be outputted through the speaker 210 and the tactile transducer 220 is selected by the controller.

Meanwhile, in the step (S1) of selecting a sound source through the controller 230, any one among a network storage, a built-in memory, and an external memory is selected, and the sound source is selected in the selected drive. In this instance, the network storage is a storage space accessible by well-known wire and wireless communication methods, such as Bluetooth or Wi-Fi, and the sound source stored in a device like a smart phone can be selected through the network storage. Moreover, in case of an insertion type external memory, an external memory, such as an USB, may be used, or a built-in memory disposed in the sound vibration module may be used.

Furthermore, in the step (S1) of selecting a sound source through the controller 230, in a state where an external sound source is selected through network memories except the built-in memory, namely, through the external memory, if the external memory is disconnected, the sound source is automatically changed into the sound source stored in the built-in memory. That is, even though wireless communication or the insertion type external memory is disconnected due to external factors or communication problems, the speaker 210 and the tactile transducer 220 do not stop operation. That is, because another sound source is automatically selected, the speaker 210 and the tactile transducer 220 keep their operations.

After the sound source is selected, in the step (S2) of retrieving melody information of the selected sound source, the sound vibration module reads melody information of the corresponding sound source.

Based on the retrieved melody information, the step (S3) of converting the melody information into a digital sound signal and a low-frequency vibration signal by the amplifier 240 is carried out. As described above, the present invention provides an auditory function and a tactile function to the user based on the melody information of the sound source. That is, the present invention can convert one sound source into signals of two sorts like a digital sound signal and a low-frequency vibration signal. Therefore, the present invention can provide low-frequency vibrations of various forms and various sound signals which are not humdrum since converting the sound source into the digital sound signal and the low-frequency vibration signal according to the selected sound source.

Additionally, in the step (S4) of outputting the converted digital sound signal through the speaker 210 and outputting the converted low-frequency vibration signal through the tactile transducer 220, a volume adjustment of the speaker and a vibration intensity adjustment of the low-frequency vibration signal can be independently performed by the controller 230. The volume adjustment of the speak and adjustment of vibration intensity of the low-frequency vibration signal can be performed by the controller 230 in proportional values, but may be performed independently.

Here, preferably, the low-frequency vibration signal outputted through the tactile transducer 220 is set to be in a range from 20 Hz to 40 Hz so as to provide various effects helpful for the human body, such as healing of muscle cells, blood flow improvement, and improvement of muscle strength by low-frequency vibration.

FIG. 6 illustrates an operating method for the bedsore-preventing mattress combined with a sound vibration module and air fibers according to another embodiment of the present invention. The operating method for the bedsore-preventing mattress according to the embodiment of the present invention further includes a step (S3′) of customizing the converted low-frequency vibration signal into another low-frequency vibration signal of the user's desired form after the step (S3) of converting the melody information into a digital sound signal and a low-frequency vibration signal by the amplifier 240 according to the retrieved melody information.

That is, the melody information is first converted into the low-frequency vibration signal by the amplifier, and then, is customized into another low-frequency vibration signal of the user's desired form to be converted second.

A range of the customizing may be reset according to the user's tastes, such as vibration intensity, and vibration speed, and changed patterns of vibration intensity and speed may be also changed into other forms.

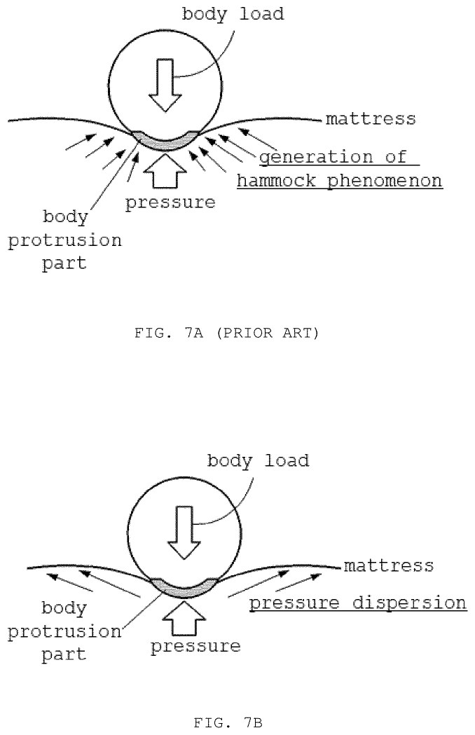

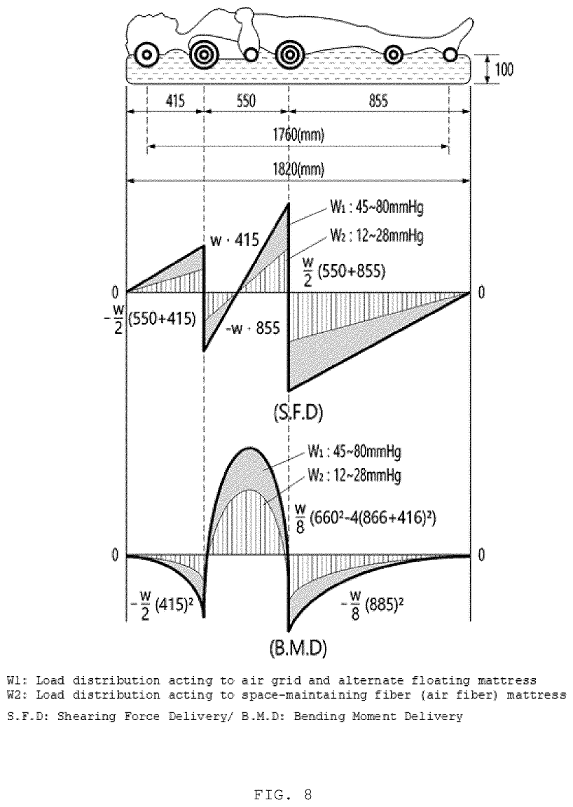

FIGS. 7 and 8 illustrate the principle that optimum dispersion of body pressure is achieved by the bedsore-preventing mattress combined with a sound vibration module and air fibers, and the operating method therefor according to the embodiments of the present invention.

FIG. 7A illustrates a load processing structure of a conventional bedsore-preventing air mattress to which an air grid and alternate floating or a tilting method are applied, In the load processing structure of a conventional bedsore-preventing air mattress, a temporary simple dispersion of body pressure is applied to the mattress and a hammock phenomenon occurs. However, as illustrated in FIG. 7B, the load processing structure of the bedsore-preventing mattress combined with the sound vibration module and air fibers according to the embodiment of the present invention can optimize pressure dispersion by applying low-frequency vibration through the sound vibration module and maintain the optimum dispersion of body pressure since the air fibers are applied.

In other words, the bedsore-preventing mattress combined with the sound vibration module and air fibers according to the embodiment of the present invention can always maintain flat upper and lower surfaces due to hundreds of thousands of the thread shanks of the air fibers serving as pillars between the upper surface and the lower surface in the air mattress since the sound vibration module and the air mattress having air fibers are applied to the bedsore-preventing mattress. Moreover, the bedsore-preventing mattress according to the embodiment of the present invention can always provide uniform partial pressure to the user's body part according to Pascal's law of action and reaction.

Additionally, referring to FIG. 8, a load distribution value W1 of the conventional mattress to which the air grid and alternate floating are applied is larger than a load distribution value W2 of the bedsore-preventing mattress combined with the sound vibration module and air fibers according to the present invention. So, the conventional mattress is insufficient for preventing bedsore since pressure higher than capillary blood pressure is distributed onto the user's hips.

That is, because the load distribution value W2 of the bedsore-preventing mattress combined with the sound vibration module and air fibers according to the present invention is smaller than the load distribution value W1 of the conventional mattress to which the air grid and alternate floating are applied, the bedsore-preventing mattress according to the present invention can remarkably improve the bedsore preventing effect due to pressure lower than capillary blood pressure.

Additionally, the bedsore-preventing mattress combined with the sound vibration module and air fibers according to the present invention can realize pressure redistribution in order to reduce pressure applied to protrusion parts since there is no hammock phenomenon.

While the preferred embodiments of the present invention have been described in more detail with reference to the accompanying drawings, but the present invention is not limited to the embodiments, and it will be understood by those of ordinary skill in the art that various modifications and equivalents may be made without deviating from the spirit or scope of the invention, and it should be construed that the modifications and equivalents belong to the scope of the present invention.

1. A bedsore-preventing mattress combined with a sound vibration module and air fibers comprising:
an air mattress including an upper fabric, a lower fabric arranged below the upper fabric to be spaced apart from the upper fabric at a predetermined interval so as to form an air cushion layer in the mattress, a plurality of air fibers of a fine thread shank type which are vertically connected between the upper fabric and the lower fabric to respond to external pressure, a lateral fabric which seals the periphery between the upper fabric and the lower fabric an air injection part disposed at one side to inject air and seal the air mattress, sound mounting recesses which are formed at both width-directional sides of one side of the longitudinal direction to be spaced apart from each other and to be recessed from the upper surface, and a sonic vibration mounting recess formed in the middle of the longitudinal direction to be recessed from the upper surface; and
a sound vibration module mounted on the air mattress and including a speaker, a tactile transducer, a controller, and an amplifier, the sound vibration module being operated to generate low-frequency vibration and to emit sound through vibration change after amplification or sound change after amplification of a sound source.

2. The bedsore-preventing mattress according to claim 1, wherein the sound vibration module which includes the speaker, the tactile transducer, the controller, and the amplifier is mounted on the air mattress, the speaker of the sound vibration module is seated and mounted on the sound mounting recess of the air mattress, the tactile transducer of the sound vibration module is seated and mounted on the sonic vibration mounting recess of the air mattress, and the controller and the amplifier of the sound vibration module are buried inwards from a lateral side of the air mattress.

3. The bedsore-preventing mattress according to claim 1, wherein the sound vibration module selectively generates low-frequency vibration which is adjusted from the sound source inputted by the manipulation of the controller into a predetermined range frequency in a low-frequency zone through the amplifier and the tactile transducer in order according to manipulation of the controller (230), and wherein the low-frequency vibration is adjusted into frequency ranging from 20 Hz to 40 Hz.

4. The bedsore-preventing mattress according to claim 1, wherein the sound vibration module selectively adjusts loudness and vibration intensity by manipulation of the controller, and
wherein the sound vibration module is operated by an algorithm that the sound source stored in the controller is outputted into sound through the amplifier and the speaker in order and that the sound source stored in the controller is outputted into sonic vibration through the amplifier and the tactile transducer in order, so that the outputted sound and sonic vibration are transferred to the user's ears and skin.

5. The bedsore-preventing mattress according to claim 1, wherein the sound vibration module further includes a sound source connection socket disclosed at one side of the controller for selectively connecting a portable storage device exposed to the outside in order to use sound sources besides the sound source stored in the controller.

6. The bedsore-preventing mattress according to claim 1, wherein the upper fabric, the lower fabric, the lateral fabric, and the air fibers of the air mattress are made with fabric or fiber yarns which are certified in antibacterial, anti-inflammation, and non-phthalate.

7. An operating method for a bedsore-preventing mattress combined with a sound vibration module and air fibers comprising the steps of:
(S1) selecting a sound source through the controller;
(S2) retrieving melody information of the selected sound source;
(S3) converting the melody information into a digital sound signal and a low-frequency vibration signal by the amplifier; and
(S4) outputting the converted digital sound signal through the speaker and outputting the converted low-frequency vibration signal through the tactile transducer,
wherein the bedsore-preventing mattress comprising :
an air mattress including an upper fabric, a lower fabric arranged below the upper fabric to be spaced apart from the upper fabric at a predetermined interval so as to form an air cushion layer in the mattress, a plurality of air fibers of a fine thread shank type which are vertically connected between the upper fabric and the lower fabric to respond to external pressure, a lateral fabric which seals the periphery between the upper fabric and the lower fabric, an air injection part disposed at one side to inject air and seal the air mattress, sound mounting recesses which are formed at both width-directional sides of one side of the longitudinal direction to be spaced apart from each other and to be recessed from the upper surface, and a sonic vibration mounting recess formed in the middle of the longitudinal direction to be recessed from the upper surface; and a sound vibration module mounted on the air mattress and including a speaker, a tactile transducer, a controller, and an amplifier, the sound vibration module being operated to generate low-frequency vibration and to emit sound through vibration change after amplification or sound change after amplification of a sound source.

8. The operating method according to claim 7, wherein the step (S1) of selecting a sound source through the controller includes the steps of first selecting a drive among wireless communication, a built-in memory, and an insertion type external memory, and selecting a sound source in the selected drive.

9. The operating method according to claim 7, wherein after the external sound source is selected from the drive of the wireless communication or the insertion type external memory, if the external memory is disconnected, the sound source is automatically changed into the sound source stored in the built-in memory.

10. The operating method according to claim 7, wherein in the step (S4) of outputting the converted digital sound signal through the speaker and outputting the converted low-frequency vibration signal through the tactile transducer, a volume adjustment of the speaker and a vibration intensity adjustment of the low-frequency vibration signal are independently performed by the controller.

11. The operating method according to claim 7, wherein in the step (S4) of outputting the converted digital sound signal through the speaker and outputting the converted low-frequency vibration signal through the tactile transducer, the low-frequency vibration signal outputted through the tactile transducer ranges from 20 Hz to 40 Hz.

12. The operating method according to claim 7, further comprising a step (S3′) of customizing the converted low-frequency vibration signal into another low-frequency vibration signal of the user's desired form after the step (S3) of converting the melody information into a digital sound signal and a low-frequency vibration signal by the amplifier 0 according to the retrieved melody information.
